(19) United States
(12) Patent Application Publication
(10) Pub. No.: US 2024/0389738 A1
(43) Pub. Date: Nov. 28, 2024

(54) RUCKING ARTICLE

(71) Applicant: GORUCK Holdings, LLC, Jacksonville Beach, FL (US)

(72) Inventor: Jason J. MCCARTHY, Atlantic Beach, FL (US)

(73) Assignee: GORUCK Holdings, LLC, Jacksonville Beach, FL (US)

(21) Appl. No.: 18/793,688

(22) Filed: Aug. 2, 2024

Related U.S. Application Data
(63) Continuation of application No. 17/508,573, filed on Oct. 22, 2021, now Pat. No. 12,053,080.
(60) Provisional application No. 63/104,193, filed on Oct. 22, 2020.

(51) Int. Cl. A45F 3/08; A45F 3/12; H04L 1/1812; H04W 72/1268; H04W 74/0816

(52) U.S. Cl. CPC A45F 3/08; A45F 3/12; H04L 1/1812; H04W 72/1268; H04W 74/0816; A45F 2003/122

(57) ABSTRACT

An embodiment of the present disclosure is an article that includes a lumbar support member, internal frame assembly, and sternum strap for improving stability during use.

### CROSS-REFERENCE TO RELATED APPLICATIONS

This application is a continuation of U.S. patent application Ser. No. 17/508,573, filed Oct. 22, 2021, which in turn claims priority to and the benefit of U.S. Provisional Patent Application No. 63/104,193 filed Oct. 22, 2020, the contents of each of the aforementioned applications incorporated herein by reference.

### TECHNICAL FIELD

The present disclosure relates to a rucking article.

### BACKGROUND

Rucking is an exercise regimen that is used in military training protocols to build strength and endurance. A person carries a weighted sack or bag while completing various activities, like running, push-ups, etc. Specially designed rucking articles can be worn like a backpack and also include compartments for holding weighted plates, or rucking plates. Stability during use is important because of a wide range of upper and lower body movements involved in traditional rucking training protocols. The rucking article should carry weight but not necessarily inhibit the users balance and agility across a wide range of body movements during use.

### SUMMARY

There is a need for rucking articles with improved stability. An embodiment includes a rucking article. The rucking article includes a base and a top spaced from the base, and lateral sides that extend from the base toward the top. The rucking article also includes a front panel coupled to the base. The rucking article also includes a back panel coupled to the base, the top, and the lateral sides. The back panel has an exterior side, an interior side opposite the exterior side, a height that extends from the base to the top, and a width that is perpendicular to the height. The rucking article also includes a plurality of pad members on the exterior side that extend across the width. A lumbar support member is located between the plurality of pad members and the base, where the lumbar support member has a thickness that is greater than a thickness of any one of the plurality of pad members. The rucking article also includes a closure that removably couples the front panel to the top and at least a portion of each of the lateral sides, such that the closure is configured to permit access to an interior of the rucking article. The rucking article also includes a pocket assembly coupled to the interior side of the back panel. The pocket assembly has at least a first pocket with a pocket width and a pocket length that is perpendicular to the pocket width, and a closure flap, where the pocket width and the pocket length is sized and selected to firmly hold a rucking plate inside the first pocket. The rucking article also includes an internal frame assembly inside a compartment of the back panel. The internal frame assembly extends from the base to the top within the compartment, such that, the internal frame assembly provides rigid support to the back panel along an entirety of the height of the back panel and the width. The rucking article also includes shoulder configured to secure the rucking article to a wearer. The rucking article also includes a sternum strap removably coupled to the shoulder straps and configured to be selectively clasped. The combination of the lumbar support member, the internal frame assembly, and the sternum strap are configured to maintain stability of the rucking article during active movement by the wearer when the rucking article is worn, and the sternum strap is clasped.

Another embodiment includes a rucking article. The rucking article also includes a base and a top opposite the base. The rucking article also includes a back panel having a bottom edge coupled to the base, a top edge opposite the bottom edge a coupled to the top, a first lateral edge, a second lateral edge opposite the first lateral edge, a height that extends from the bottom edge to the top edge, a width perpendicular to the height, an exterior side that faces a user's back when the rucking article is worn by the user, and an interior side opposite the exterior side. The rucking article also includes a first lateral side and a second lateral side opposite the first lateral side such that the first and second lateral sides defining a depth of the rucking article that is perpendicular to the height and the width. The rucking article also includes a first closure element that extends along at least a portion of the top edge, the first lateral side, and the second lateral side. The rucking article also includes a front panel coupled to the base, the front panel having an outer perimeter. A second closure element extends along a majority of the outer perimeter of the front panel and is configured to selectively engage the first closure element to open or close access to an internal space of the rucking article. The rucking article also includes a plurality of support pads along the exterior side and adjacent to the top edge of the back panel. A lumbar support member is located along the exterior side and adjacent to the bottom edge, the first lateral edge, and the second lateral edge. The lumbar support member extends from the bottom edge of the base toward the top a distance that is between 20% and 30% of the height of the back panel. The lumbar support member projects outwardly relative to the plurality of support pads. The rucking article also includes an internal frame assembly encased within the back panel and that extends from the bottom edge of the back panel to top edge of the back panel, and between the first and second lateral edges. The rucking article also includes shoulder straps to secure the article to the wearer. The rucking article also includes a sternum strap removably coupled to the first shoulder strap and the second shoulder strap, the sternum strap having a releasable clasp to selectively open and close the sternum strap.

### BRIEF DESCRIPTION OF THE DRAWINGS

The foregoing summary, as well as the following detailed description of illustrative embodiments of the present application, will be better understood when read in conjunction with the appended drawings. For the purpose of illustrating the present application, there is shown in the drawings illustrative embodiments of the disclosure. It should be understood, however, that the application is not limited to the precise arrangements and instrumentalities shown. In the drawings:

FIG. 1 is a front perspective view of a rucking article according to an embodiment of the present disclosure;

FIG. 2 is a rear view of the rucking article shown in FIG. 1;

FIG. 3 is a side view of the rucking article shown in FIG. 1;

FIG. 4 is a bottom view of the rucking article shown in FIG. 1;

FIG. 5 is a top view of the rucking article shown in FIG. 1;

FIG. 6 is a plan view of a front panel assembly of rucking article shown in FIG. 1;

FIG. 7 is an interior view of the front panel assembly shown in FIG. 6;

FIG. 8 is an interior view of the back panel of the rucking article shown in FIG. 1;

FIG. 9 is a plan view of the exterior of the back panel shown in FIG. 8;

FIG. 10 is a schematic cross-sectional view of the back panel shown in FIG. 8, taken line I-I;

FIG. 11 is another side view the rucking article shown in FIG. 1, with shoulder straps removed to illustrate the lumbar support members;

FIG. 12A is a plan view of a rucking plate according to an embodiment of the present disclosure; and

FIG. 12B is a perspective view of a rucking plate according to an embodiment of the present disclosure.

### DETAILED DESCRIPTION OF ILLUSTRATIVE EMBODIMENTS

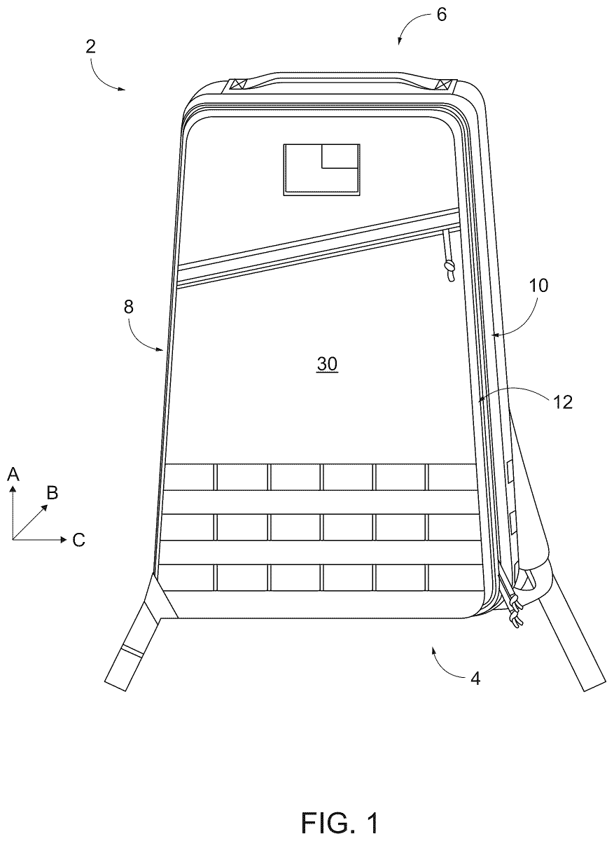

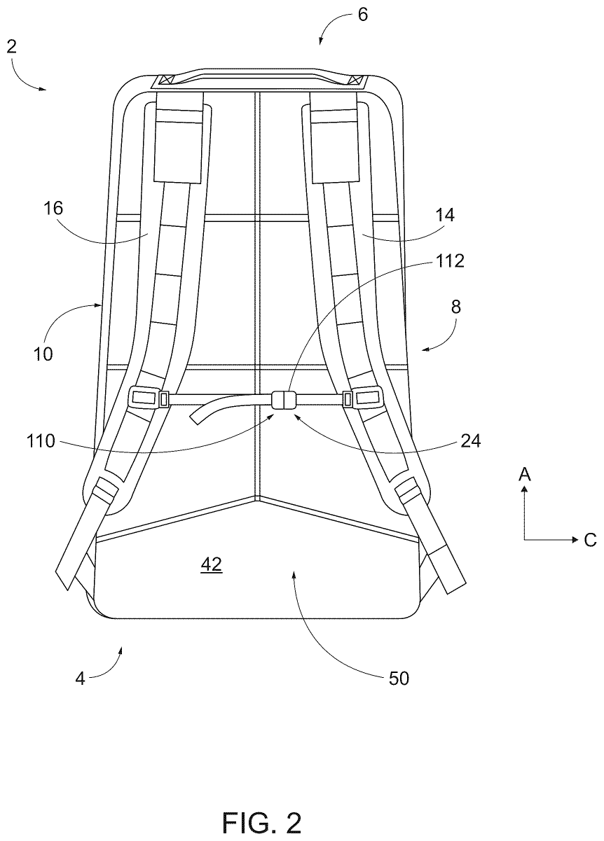

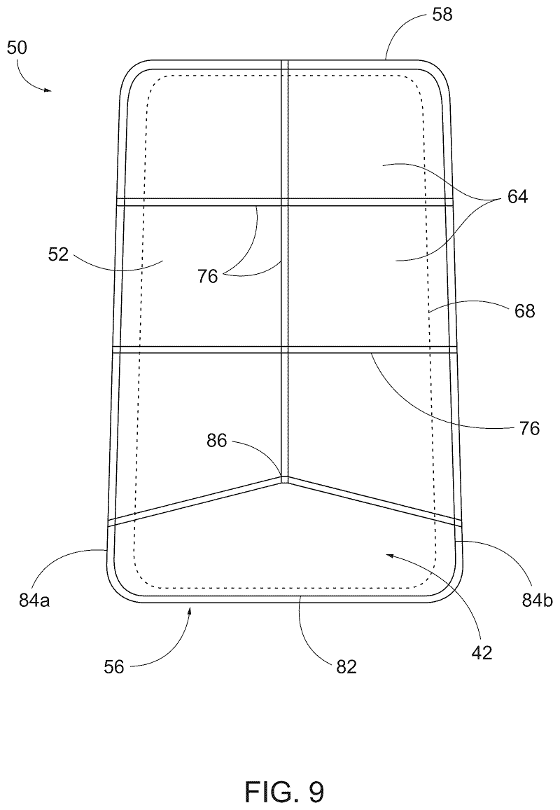

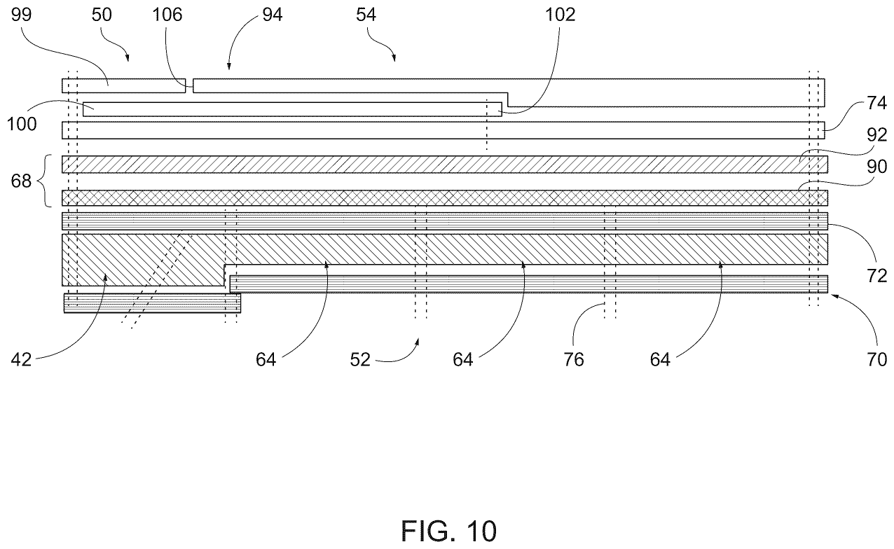

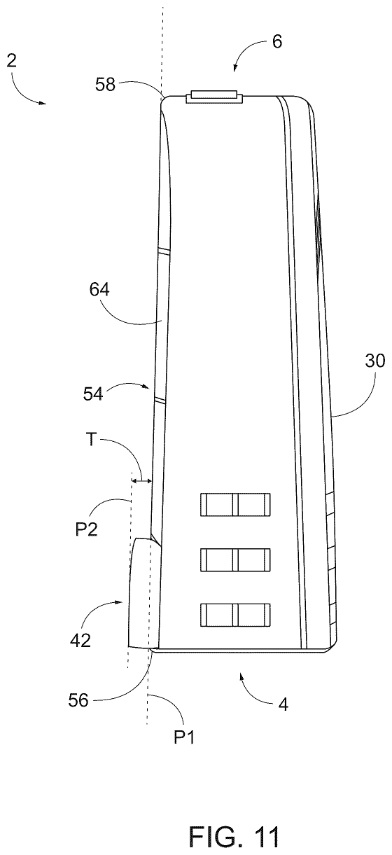

Embodiments of the present disclosure includes a rucking article. A rucking article may be referred to as a rucking sack, rucker, or ruck sack, and is specifically configured to hold weighted plates, e.g. ruck plates. The rucking article is designed to be carried, lifted, etc., by the user, during physical activity as a training regimen. The rucking article 2 according to an embodiment of the present disclosure includes a combination of features that improves stability when worn and when the user engages in an exercise regimen that involves a wide range of upper and lower body movements. More specifically, the inclusion of lumbar support members 42 (FIG. 1), a rigid internal frame assembly 68 (FIGS. 9, 10), and a sternum strap 24 (FIG. 2) combine to establish both rucking article stability and rigid support that helps better distribute loads across the user's upper and lower back during use. Stability and rigid support are advantageous results of the construction of the rucking article described herein, especially when the user is carrying weighted plates inside the article while also engaging in strenuous exercise.

Referring to FIGS. 1 and 2, the rucking article 2 includes a base 4, a top 6 spaced from the base 4, lateral sides 8, 10, a front panel 30 coupled to the base 4, and a back panel 50 coupled to the base 4, the top 6, and lateral sides 8, 10. A pair of shoulder straps 14, 16 are configured to secure the rucking article 2 to a user and the sternum strap 24 is removably coupled to the shoulder straps 14, 16 to contribute to article stability during use, as described above. A closure system 12 may be used to selectively open and close the rucking article 2 to permit access to an interior of the article 2, as will be further described below.

As shown in FIGS. 1 and 2, the base 4 and top 6 are spaced apart along a height direction A, the front panel and back panel are spaced part along a depth direction B, and the lateral sides 8,10 extend between the front panel 30 and the back panel 50 along a depth direction B. The lateral sides 8, 10 are spaced apart with respect to each other along a lateral (or width) direction C. Thus, the height direction A is substantially perpendicular to the depth direction B and lateral direction C. The orthogonal directions A, B, and C are used in the present disclosure only for illustrative purposes to aid in clarifying the relative positions of components of the rucking article 2.

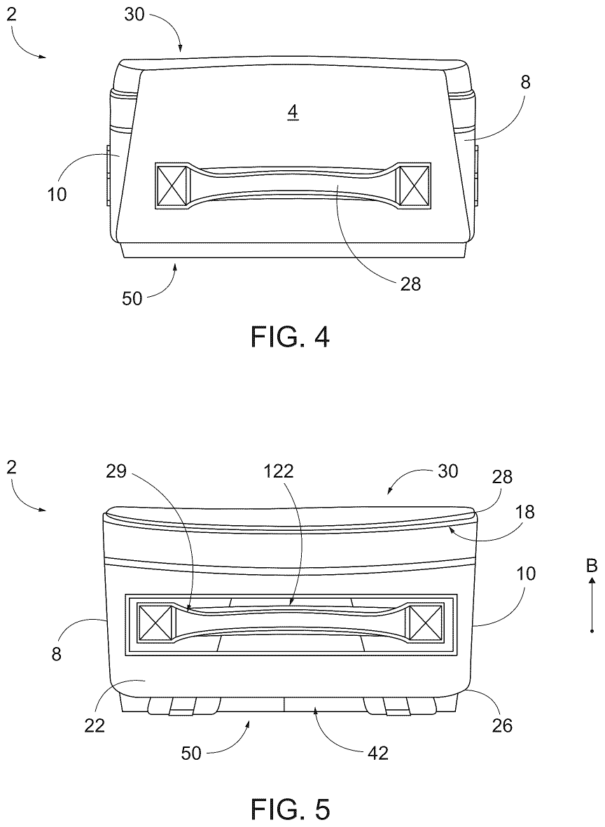

As shown in FIG. 4, the base 4 of the rucking article 2 includes opposed inner and outer edges and opposed sides (not numbered) that extend between the opposed inner and outer edges (not numbered). The base 4 is comprised of durable woven fabrics that may encase a cushion member, e.g. a foam, felt, batting, or other compressible material.

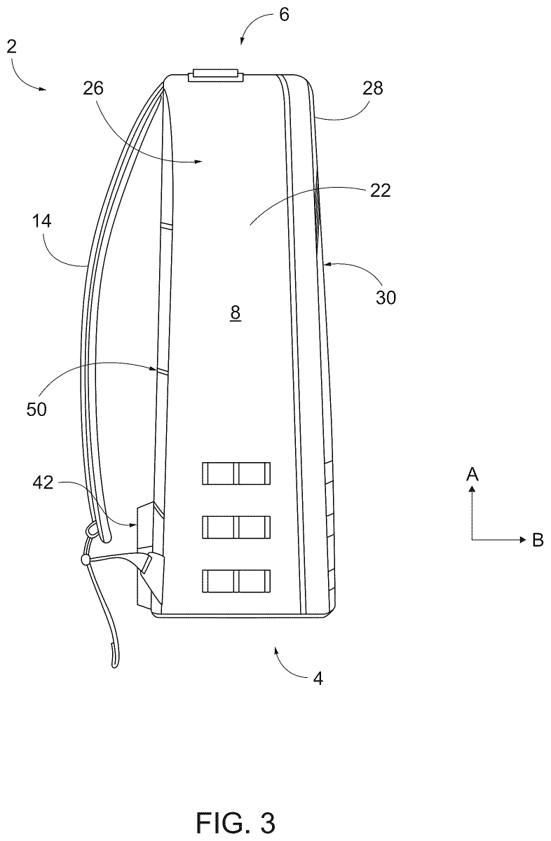

Referring to FIGS. 3 and 4, the lateral sides 8, 10 and the top 6 may be defined by a sidewall assembly 22 that is fixed to the back panel 50 and base 4. In the illustrated embodiment, the sidewall assembly 22 defines a rearward edge 26 coupled to the base 4 and the back panel 50 and an outward edge 28 that includes the first closure element 18 of the closure system 12. The closure system 12 thus removably secures a portion of the front panel 30 to the sidewall assembly 22. In alternative embodiment, however, the top 6 and lateral sides 8, 10 could also be separate components that are coupled together. The sidewall assembly 22 may be comprised of durable woven fabrics that may optionally encase a cushion member.

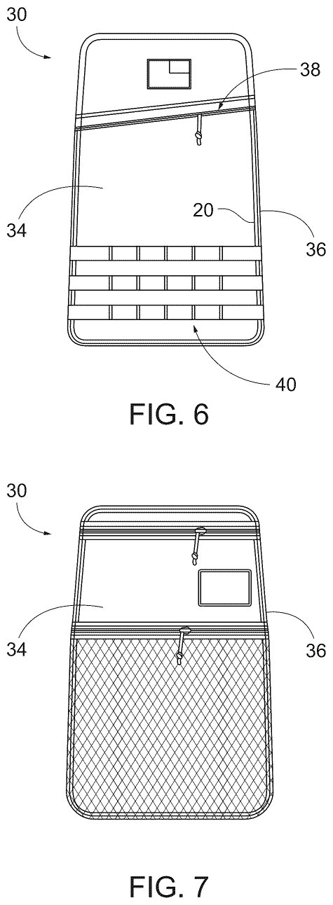

Referring to FIGS. 3, the front panel 30 is coupled to the base 4 and removably coupled to the top 6 and lateral sides 8, 10 via the closure system 12. Referring to FIGS. 6 and 7, the front panel 30 has an exterior side 32, shown in FIG. 6, an interior side 34, shown in FIG. 7, and an outer perimeter 36. The exterior side 32 includes an external zippered pocket 38 and webbing loops 40 located toward a bottom end (not numbered) of the front panel 30. Webbing loops 40 may be used to removably couple various items to the rucking article 2. The interior side 34 includes several pockets (not numbered) for holding items as needed, as best shown in FIG. 7. The front panel 30 includes a closure element 20 of the closure system 12. As illustrated the closure element 20 extends along a majority of the outer perimeter 36, for example, along the both lateral sides and top of the outer perimeter 36. The front panel is comprised of durable woven fabrics and may include high tenacity yarns to form the woven fabrics.

FIGS. 1-4 illustrate the back panel 50. The back panel 50 is shown coupled to the base 4, the top 6, and the lateral sides 8, 10 and removably coupled to front panel 30. In terms of construction, the back panel 50 has a bottom edge 56 coupled to the base 4, a top edge 58 opposite the bottom edge 56 coupled to the top 6, a first lateral edge 60, and a second lateral edge 62 opposite the first lateral edge 60. The back panel 50 has an exterior side 52 that faces a user's back when the rucking article 2 is worn by the user, and an interior side 54 opposite the exterior side 52. The back panel 50 defines a panel height H that extends from the bottom edge 56 to the top edge 58 and a width W that is perpendicular to the height H. Referring to FIG. 10, which is a schematic cross-section of the back panel 50, the back panel 50 has one or more panel layers that hold and secure various components of the back panel 50 as further explained below.

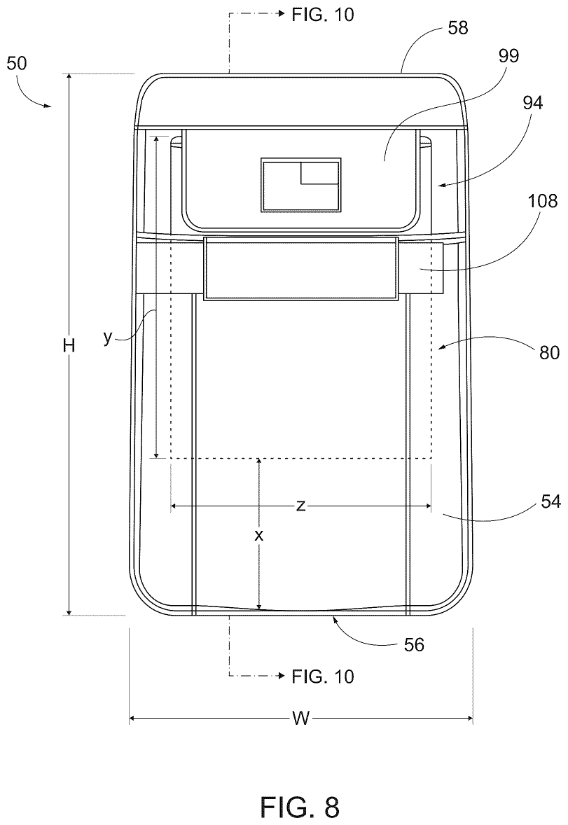

Referring to FIGS. 8-10, the back panel 50 includes a plurality of pad members 64, a lumbar support member 42, and an internal frame assembly 68 encased within the back panel 50. An exterior panel layer 70 defines the exterior side 52 of the panel 50. The exterior panel layer 70 and interior panel layer 72 encase one or more cushion elements, which form and define the plurality of pad members 64 and lumbar support member 42. The cushion elements may comprise an open cell foam, closed cell foam or any other compressible and resilient material suitable to provide support. In one useful example, the lumbar support member 42 comprises a cross-linked polyolefin foam and the plurality of pad members comprise cross-linked polyolefin foam. Adjacent to the interior panel layer 72 is the internal frame assembly 68 and adjacent to that is another panel layer 74, to which the pocket assembly 80 is attached. Panel layer 74 may define a portion of the interior side 54 of the back panel 50. A plurality of stitch lines 76 along the exterior panel layer 70 define the size and shape of the plurality of pad members 64 and the lumbar support member 42. The plurality of pad members 64 are shown located on the exterior side 54, extend across the width with back panel 50, and biased toward the top 6 of the article 2. The lumbar support member 42 itself is located between the plurality of pad members 64 and the base 4 and is positioned to support a user's lower back when the rucking article 2 is worn.

Continuing with FIGS. 8-10, it is the size, shape, and position of the lumbar support member 42 that contributes to overall article stability and lower back support. In the illustrated embodiment, the lumbar support member 42 has a base side 82, a first lateral side 84a, a second lateral side 84b opposite the first lateral side 84a, an apex 86 spaced from base side 82, a first top edge 88a that extends from the first lateral side 84a to the apex 86, and a second top edge 88b that extends from the second lateral side 84b to the apex 86. As shown, the first top edge 88a and the second top edge 88b are angularly offset with respect to the first lateral side 84a and the second lateral side 84b, respectively. The lumber support member 42 may have other shapes and configurations as needed. For instance, the first and second top edges 88a and 88b may be substantially perpendicular to the lateral sides 84a and 84b. There may be multiple separate lumbar support members, as needed.

The lumbar support member 42, or multiple lumber support members as the case may be, has coverage across the back panel 50 that contributes to desired article stability during use. For example, in the illustrated embodiment, the lumbar support member 42 extends across an entirety of the width W of the back panel 50. Furthermore, the lumber support member 42 extends between 10% and 25% of the total height H of the back panel 50.

As shown in FIG. 10, the lumbar support member 42 projects outwardly relative to the pad members 64 sufficient to allow the lumber support member 42 to contact the user's lower back while allowing the pad members 64 to contact the user's upper back. More specifically, the lumbar support member 64 has an overall thickness that is greater than a thickness of any one of the plurality of pad members 64. Here, we define the thickness T as the difference between elevation of the lumber support member 42 and the pad members 64. In this regard, the plurality of pad members defines a plurality of planar contact surfaces (not numbered) that lie along a first plane P1, and the lumbar support member 42 defines a contact surface (not numbered) that lies along a second plane P2. The thickness T is the distance between planes P1 and plane P2 (along a perpendicular line that intersects both planes P1, P2. In the embodiment shown, the thickness T is between 0.25 inches to 0.5 inches. In one example, the thickness T is 0.25 inches. In another example, the thickness T is 0.3 inches. In another example, the thickness is 0.375 inches, in another example, the thickness is 0.40 inches. In another example, the thickness is 0.5 inches. The thickness T may fall outside these ranges. However, a thickness T between 0.25 and 0.50 inches is particularly useful when combined with other stability features, such as the internal frame assembly 68 and sternum strap 24.

Referring to FIGS. 9 and 10, an internal frame assembly 68 encased within the back panel 50. In the illustrated embodiment, the internal frame assembly 68 comprises a planar rigid member 90 and a foam layer 92 sitting adjacent the planar rigid member 90. The planar rigid member may be a plastic sheet or metallic sheet as needed. It may comprise a monolithic component or could be multiple components stitched together. It may include through holes or openings for weight reduction. The planar rigid member 90, however, has a size and shape that generally extends across a substantial entirety of the width of the back panel 50 and a substantial entirety of the height H of the back panel 50. The foam layer 92 sits adjacent the planar rigid member and is generally coextensive with the height and width of the planar rigid member. In other words, the foam layer 92 and planar rigid member 90 have a similar size and shape. The internal frame assembly 68 therefore supports the integrity of the article as it is weighed down, which allows a user to carry a heavier load more comfortably, and also contributes to article stability during use.

Referring to FIGS. 8 and 10, the rucking article 2 is configured to hold weighted plates with a pocket assembly 94. The pocket assembly 94 is coupled to the interior side 54 of the back panel 50 and has at least a first pocket 96 and a second pocket 98. Each of the first and second pockets 96 and 98 are sized and selected to firmly hold a rucking or weighted plate therein. The first pocket 96 has a first pocket panel 100 attached to the interior side 54 of the back panel 50, which defines a pocket length Y and the pocket width Z. A closure flap 99 is secured to the back panel 50 and is used to open or close access to the first pocket 94. As illustrated, the first pocket panel 100 is spaced apart from the base 4 and lies approximate the top 6, such that the first pocket panel 98 is biased toward the top of the back panel 50. More specifically, a bottom end 102 of the pocket panel 100 is spaced from a bottom edge of back panel a distance X that is between 20% and 30% of a total height H of the back panel 50.

The pocket assembly design works on conjunction with the other design elements of the rucking article 2. In this regard, the first pocket does not overlie any portion of the lumbar support member 42 along the exterior side of the back panel. In other words, the first pocket is positioned inside the rucking article 2 so that it does interfere with position and use of the lumbar support member 42. In use, this can be important as it the pocket position keeps the weight elevate on the user's back and permits the lumbar support member 42 to provide support where it is designed to-the lower back. This, in turns, helps create improved stability for wearer by aiding even distribution of loads by the internal frame assembly. The sternum strap 24, in turn, also aids stability by helping position the weighted plate where it is intended to be—the users upper back off of the lumbar area.

The second pocket 96 has a second pocket panel 104 that overlies the first pocket panel 100. The second pocket panel 104 defines a top edge 106 that sits below the closure flap 99 with the closure flap 99 in a closed position. The second pocket 96 may be gusseted or pleated to accommodate one or more plates. An elastic strap 108 extends across the top of the second pocket to help secure items therein.

The rucking article 2 includes shoulder straps 8, 10 that extends between the top and lateral sides proximate the top and partially overly the back panel 50. The shoulder straps configured to secure the rucking article 2 to a wearer. In certain embodiments, the shoulder straps 8, 10 are extra padded to carry heavier loads more comfortably.

The sternum strap 24 is removably coupled to the shoulder straps and configured to be selectively clasped as needed to facilitate improved stability. The sternum strap includes a first strap portion (not shown) removeable coupled to shoulder strap 8, a first clasp member 110 slidably positioned along the first strap portion and second strap portion, and a second clasp member slidably positioned along the second strap portion. The first and second clasp members can be connected together as needed. The sternum strap can be repositioned along different loops coupled to the shoulder strap to adjust the positioning of the strap 24 relative to the user. The combination of the lumbar support members 42 (FIG. 1), a rigid internal frame assembly 68 (FIGS. 9, 10), and a sternum strap 24 (FIG. 2) are configured to maintain stability of the rucking article 2 during active movement by the wearer when the rucking article is worn and the sternum strap is clasped.

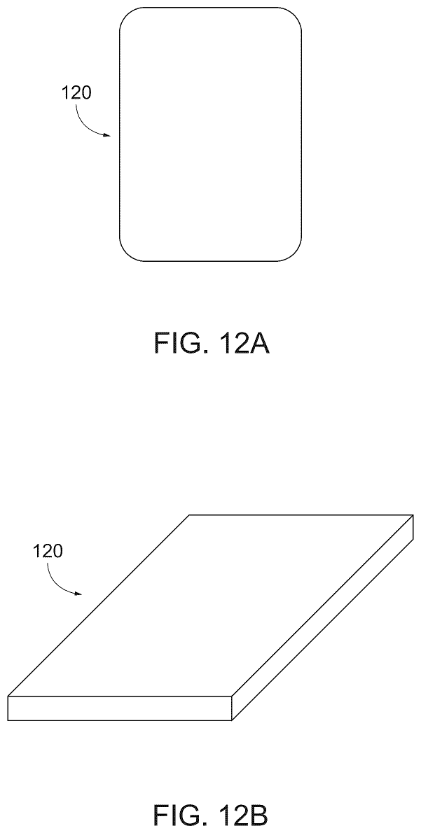

FIGS. 12A and 12B illustrate an exemplary weighted plate 120 for insertion in the first and second pockets 94 and 96. Each weighted plate 120 has a length, width, and thickness (not numbered) that are selected so that the weighted plates slidingly fit within the pocket 94 or pocket 96 without substantially movement therein. In other words, the pockets 94, 96 and plates 120 have similar dimensions. The weighted plates have a variety of weights. For example, the weighted plate may be 10 lbs., 15 lbs., 20 lbs., 25 lbs., 30 lbs., 35 lbs., 40 lbs. 45 lbs. or 50 lbs.

Referring now to FIGS. 1 and 3, the closure system 12 may be used to selectively open and close the rucking article 2 to permit access to an interior of the article 2. The closure system 12 includes a first closure element 18 fixed to an entirety of the outward edge 28 of the sidewall assembly 22. A second closure element 20 is fixed to the top and side edges of the front panel assembly 22. The front panel 30 is coupled, or fixed, to the base 4. The first and second closure elements 18 and 20 are thus configured to selectively engage with each other so that a portion of the front panel 20 is removably coupled to the top 6 and at least a portion of each of the lateral sides 8, 10 of the rucking article 2. In this configuration, the rucking article 2 can open flat so that it is easier to access the internal pockets and otherwise organize its contents. In alternative embodiments, the closure system 12, e.g. the first and second closure elements 18, 20, may extend along only a portion of the lateral sides and/or top of the rucking article 2. For example, the closure system 12 may extend along only the top of the rucking article 2. In various embodiments of the rucking article 2, the closure system 12, e.g. a zipper, can be made with silent, glove friendly zipper pulls constructed from parachute cord, which, in one example is a 550 denier cord. Other types of closures, pulls, and cord sizes may be used.

Referring to FIGS. 4 and 5, the base 4 also includes a durable handle 28 that can be used to grab the article as described further below and the top 6 include a durable handle 29. Though not shown, the lateral sides can further comprising side durable handles. The base 4 may include various reinforced drainage ports allowing fluid to pass through as needed. The rucking article 2 may also include a hip belt assembly coupled thereto proximate the base 4. The top 6 also includes a port 122 (FIG. 5) with a hook and loop closure overlying the port. The port is sized for a tube of a hydration bladder positionable inside the rucking article 2. Hi visibility straps may be used as a reflective member and are paced along straps and on front panel for safety.

Each of the various components, such as the back panel, front panel, top, base, and sides are comprised of durable woven fabrics. The article is comprised of tear and wear resistant fabrics comprised of 1000 denier CORDURA® yarns. Any number of weave constructions and deniers may be used, however. However, a less abrasive fabric may be used on the back panel and underside of the shoulder straps to reduce friction and the like. The back panel and shoulder straps, for example, may be comprised of woven fabrics comprising 210 denier, High Tenacity CORDURA® yarns.

The rucking article 2, in general, has a size and shape to fit comfortably on the user's upper torso. More specifically, the rucking article 2 has overall width W that extends from one side to other side, an overall height H that extends from the base 4 to the top 6 and that is perpendicular to the overall width W, and an overall depth D that extends from an exterior side 54 of the back panel 50 to the an exterior side 32 of the front panel 30. The overall depth D is substantially perpendicular to the overall height H and the overall width W. In one exemplary embodiment, the rucking article 2 has an overall width W between 10.0 inches and 13.0 inches, an overall height H between 15.0 inches and 22.0 inches, and an overall depth D is between 4.0 inches and 7.25 inches. Furthermore, the rucking article 2 is designed to have an overall weight that can vary between about 2.30 lbs. and about 3.30 lbs. In some cases, the overall article weight may vary outside of these specific ranges.

While the disclosure is described herein, using a limited number of embodiments, these specific embodiments are not intended to limit the scope of the disclosure as otherwise described and claimed herein. The precise arrangement of various elements and order of the steps of articles and methods described herein are not to be considered limiting. For instance, although the steps of the methods are described with reference to sequential series of reference signs and progression of the blocks in the figures, the method can be implemented in an order as desired.

1. A rucking article, comprising:
a base;
a top spaced from the base;
lateral sides that extend from the base toward the top;
a front panel coupled to the base;
a back panel coupled to the base, the top, and the lateral sides, the back panel having an exterior side, an interior side opposite the exterior side, a height that extends from the base to the top, and a width that is perpendicular to the height;
a plurality of pad members on the exterior side that extend across the width, each of the plurality of pad members formed by a cushion element made of compressible and resilient material;
a closure that removably couples the front panel to the top and at least a portion of each of the lateral sides, such that the closure is configured to permit access to an interior of the rucking article;
a pocket assembly coupled to the interior side of the back panel, the pocket assembly having at least a first pocket;
an internal frame assembly inside a compartment of the back panel, the internal frame assembly extending from the base to the top within the compartment, such that, the internal frame assembly provides rigid support to the back panel along a height of the back panel and the width, the internal frame assembly comprising a planar rigid member and another layer, the planar rigid member extending across the width of the back panel and the height of back panel, wherein the another layer is substantially adjacent to and coextensive with the planar rigid member; and
shoulder straps configured to secure the rucking article to a wearer.

2. The rucking article of claim 1, wherein the exterior side of the back panel has a plurality of stitch lines that define a size and shape of the plurality of pad members.

3. The rucking article according to claim 1, wherein the first pocket has a first pocket panel attached to the interior side of the back panel, wherein the first pocket panel defines a pocket length and a pocket width, wherein the first pocket panel is spaced apart from the base and lies proximate the top, such that the first pocket panel is biased toward the top of the back panel.

4. The rucking article according to claim 1, wherein a bottom end of the first pocket panel is spaced from a bottom edge of back panel a distance that is between 20% and 30% of a total height of the back panel.

5. The rucking article according to claim 1, wherein the pocket assembly includes a second pocket comprising a second pocket panel that overlies the first pocket panel, wherein the second pocket panel defines a top edge that sits below the closure flap with the closure flap is in a closed position.

6. The rucking article according to claim 1, wherein the internal frame assembly comprises a planar rigid member and a foam layer adjacent to the planar rigid member.

7. The rucking article according to claim 1, further comprising a rucking plate having a length and width selected to slidingly fit within a pocket of the pocket assembly.

8. The rucking article according to claim 1, wherein the rucking plate is between 15 lbs. and 45 lbs.

9. The rucking article according to claim 1, further comprising a lumbar support member located on the back panel.

10. The rucking article according to claim 1, wherein the plurality of pad members each define a planar contact surface that lies along a first common plane.

11. A rucking article, comprising:
a base;
a top opposite the base;
a back panel having a bottom edge coupled to the base, a top edge opposite the bottom edge a coupled to the top, a first lateral edge, a second lateral edge opposite the first lateral edge, a height that extends from the bottom edge to the top edge, a width perpendicular to the height, an exterior side that faces a user's back when the rucking article is worn by the user, and an interior side opposite the exterior side;
a first lateral side and a second lateral side opposite the first lateral side, the first and second lateral sides defining a depth of the rucking article that is perpendicular to the height and the width,
a first closure element that extends along at least a portion of the top edge, the first lateral side, and the second lateral side;
a front panel coupled to the base, the front panel having an outer perimeter;
a second closure element that extends along a majority of the outer perimeter of the front panel, the second closure element configured to selectively engage the first closure element to open or close access to an internal space of the rucking article;
a plurality of pad members along the exterior side; each of the plurality of pad members formed by a cushion element made of compressible and resilient material;
a pocket assembly having a pocket adjacent the interior side of the back panel
an internal frame assembly encased within the back panel and that extends from the bottom edge of the back panel to top edge of the back panel, and between the first and second lateral edges, the internal frame assembly comprising a planar rigid member and another layer, the planar rigid member extending across the width of the back panel and the height of back panel, wherein the another layer is substantially adjacent to and coextensive with the planar rigid member; and
shoulder straps that extend from a top edge of the back panel toward the lateral sides edges or bottom edge of the back panel.

12. The rucking article of claim 11, wherein the exterior side of the back panel has a plurality of stitch lines that define a size and shape of the plurality of pad members.

13. The rucking article according to claim 11, wherein the plurality of pad members define a plurality of planar contact surfaces that lie along a first plane.

14. The rucking article according to claim 11, wherein the pocket comprises a first pocket panel attached to the interior side of the back panel, wherein the first pocket panel defines the pocket length and the pocket width, wherein the first pocket panel is spaced apart from the base and lies proximate the top, such that the first pocket panel is biased toward the top of the back panel.

15. The rucking article according to claim 11, wherein a bottom end of the first pocket panel is spaced from a bottom edge of back panel a distance that is between 20% and 30% of a total height of the back panel.

16. The rucking article according to claim 11, wherein the pocket assembly includes another pocket comprising a second pocket panel that overlies the first pocket panel, wherein the second pocket panel defines a top edge that sits below the closure flap with the closure flap is in a closed position.

17. The rucking article according to claim 11, wherein the internal frame assembly comprises a planar rigid member and a foam layer adjacent to the planar rigid member.

18. The rucking article according to claim 11, further comprising a rucking plate having a length and width selected to slidingly fit within a pocket of the pocket assembly.

19. The rucking article according to claim 11, wherein the rucking plate is between 15 lbs. and 45 lbs.

20. The rucking article according to claim 11, further comprising a lumbar support member located on the back panel.
